(19) United States
(12) Patent Application Publication
(10) Pub. No.: US 2026/0023776 A1
(43) Pub. Date: Jan. 22, 2026

(54) AUTOMATIC HELPDESK EXPLAINER

(71) Applicant: Aristocrat Technologies, Inc., Las Vegas, NV (US)

(72) Inventor: Kory Kirk, Fort Collins, CO (US)

(21) Appl. No.: 18/776,072

(22) Filed: Jul. 17, 2024

(51) Int. Cl. G06F 16/383; G06F 16/35; G06T 11/20

(52) U.S. Cl. CPC G06F 16/383; G06F 16/353; G06T 11/206

(57) ABSTRACT

An automated helpdesk explainer for use by a customer-support ticket platform is integrated with an online gaming platform. The automated helpdesk explainer receives a plurality of helpdesk tickets and determines a ticket volume parameter based on the plurality of helpdesk tickets. In response to the ticket volume parameter satisfying a predefined threshold, the automated helpdesk explainer applies one or more of the plurality of helpdesk tickets to a natural language processor configured to assign the one or more of the plurality of helpdesk tickets to one or more topics, creates an infographic image representing the one or more of the plurality of the helpdesk tickets based on the topics, applies at least a portion of the topics to a large language model configured to generate a natural language incident analysis summary, and provides the infographic image and incident analysis summary for presentation at a client device.

### BACKGROUND

A customer support ticketing system is a software application that allows businesses to manage and track customer inquiries and issues. When a customer submits a complaint or query, a ticket is created. Each ticket acts as a detailed conversation thread about a specific problem, request, or query. It contains essential information such as customer details, the nature of the issue, and other relevant data. These tickets can then be assigned to appropriate customer support agents, who track and work on them until resolution.

Typically, when a customer submits a query or reports an issue, it is converted into a ticket within the software. This ticket includes all necessary information related to the issue. Customer service representatives can view and manage these tickets from a centralized dashboard. The ticketing system allows representatives to track communication history, collaborate on solutions, and prioritize tasks. Both the customer and the support agent can refer back to the ticket thread at any point in time, ensuring continuity and efficient problem-solving. Customer-support ticketing systems may, at times, be overwhelmed with an overwhelming number of tickets. Some customer-support ticketing systems may benefit from a software tool to provide analytics of customer service requests and tickets.

Platforms like Zendesk® and Salesforce® offer customer service analytics but they are not tailored for the gaming industry. Specifically, they require manual intervention for advanced analytics and lack real-time data analysis. What is needed is a tool that automates the entire process from data collection to analysis and visualization.

### SUMMARY

Systems and methods disclosed relate to, inter alia, an automated helpdesk explainer for an online gaming platform. The automated helpdesk agent may, in some cases, be implemented as part of a cloud-based platform. Additionally, or alternatively, the automated helpdesk explainer may be implemented as part of a customer-support ticketing system. The customer-support ticketing system may be provided, for example, as part of an online gaming platform. The online gaming platform may support a plurality of interconnected user devices over a network.

In one aspect, an automated helpdesk explainer computing device including at least one processor in communication with a memory device may be provided. The at least one processor may be configured to: (i) receive a plurality of helpdesk tickets, (ii) determine a ticket volume parameter based on the plurality of helpdesk tickets, and (iii) in response to the ticket volume parameter satisfying a predefined threshold: (iv) apply one or more of the plurality of helpdesk tickets to a natural language processor configured to assign the one or more of the plurality of helpdesk tickets to one or more topics, (v) create an infographic image representing the one or more of the plurality of the helpdesk tickets based on the topics, (vi) apply at least a portion of the topics to a large language model configured to generate a natural language incident analysis summary, and (vii) provide the infographic image and incident analysis summary for presentation at a client device. The automated helpdesk explainer computing device may include additional, less, or alternate functionality, including that discussed elsewhere herein.

In another aspect, a computer-based method implemented using an automated helpdesk explainer computing device may be provided. The automated helpdesk explainer computing device may include at least one processor in communication with a memory device, and the computer-based method may include: (i) receiving a plurality of helpdesk tickets, (ii) determining a ticket volume parameter based on the plurality of helpdesk tickets, and (iii) in response to the ticket volume parameter satisfying a predefined threshold: (iv) applying one or more of the plurality of helpdesk tickets to a natural language processor configured to assign the one or more of the plurality of helpdesk tickets to one or more topics, (v) creating an infographic image representing the one or more of the plurality of the helpdesk tickets based on the topics, (vi) applying at least a portion of the topics to a large language model configured to generate a natural language incident analysis summary, and (vii) providing the infographic image and incident analysis summary for presentation at a client device. The computer-based method may include additional, less, or alternate actions, including those discussed elsewhere herein.

In yet another aspect, at least one non-transitory computer-readable storage media having computer-executable instructions embodied thereon may be provided that, when executed by at least one processor in communication with a memory device, the computer-executable instructions may cause the processor to: (i) receive a plurality of helpdesk tickets, (ii) determine a ticket volume parameter based on the plurality of helpdesk tickets, and (iii) in response to the ticket volume parameter satisfying a predefined threshold: (iv) apply one or more of the plurality of helpdesk tickets to a natural language processor configured to assign the one or more of the plurality of helpdesk tickets to one or more topics, (v) create an infographic image representing the one or more of the plurality of the helpdesk tickets based on the topics, (vi) apply at least a portion of the topics to a large language model configured to generate a natural language incident analysis summary, and (vii) provide the infographic image and incident analysis summary for presentation at a client device. The computer-executable instructions may cause additional, less, or alternate actions, including those discussed elsewhere herein.

In one or more implementations, each of the above-described features, and variations thereof, may be implemented as a series of computer executable instructions executed on a programmable electronic device. Such instructions may use any one or more convenient programming language. Such instructions may be collected into engines and/or programs and stored in any computer-readable medium or media that is readable and executable by a computer system, gaming device, or other programmable electronic device.

### BRIEF DESCRIPTION OF THE DRAWINGS

FIG. 1 depicts an exemplary networked computing system in accordance with one or more embodiments of the present disclosure.

FIG. 2 depicts an exemplary client computing device that may be used with the networked computing system shown in FIG. 1 in accordance with one or more embodiments of the present disclosure.

FIG. 3 depicts an exemplary application flow diagram of a cloud-based helpdesk explainer in accordance with one or more embodiments of the present disclosure.

FIG. 4 depicts an exemplary architecture diagram in accordance with one or more embodiments of the present disclosure.

FIGS. 5A-5D depict example alerts generated by the application flow diagram in accordance with one or more embodiments of the present disclosure.

FIG. 6 depicts an example flow diagram in accordance with one or more embodiments of the present disclosure.

### DETAILED DESCRIPTION

The detailed description is directed to various embodiments of techniques for generating and presenting customer service metrics for a customer service ticketing platform via a cloud-based automated helpdesk explainer. Various embodiments described herein relate to use of the cloud-based automated helpdesk explainer to automatically summarize what users, or customers, are submitting tickets about (e.g., feedback, complaints, issues) with respect to a software application (e.g., mobile game, mobile app, etc.). In some embodiments of the disclosed technology, the cloud-based automatic helpdesk explainer may be integrated as part of a customer-support ticketing system of an online gaming platform. In at least one exemplary embodiment, processes described herein may be performed and implemented by a server computing device described herein.

In some embodiments of the disclosed technology, a cloud-based software tool may be provided. The cloud-based software tool may be used by, for example, a customer-support ticketing system of an online gaming platform. The cloud-based software tool may, in some cases, be specifically designed to collect, process, analyze, and graphically present customer service ticket metrics. The cloud-based software tool may collect, process, analyze, and graphically present customer service ticket metrics in the gaming industry. Additionally, or alternatively, the cloud-based software tool may collect, process, analyze, and graphically present customer service ticket metrics in other industries that use customer service ticketing systems (e.g., enterprise applications, online payment services, e-mail applications, etc.).

In some embodiments of the disclosed technology, a cloud-based software tool may be provided. The cloud-based software tool may be used by, for example, a customer-support ticketing system of an online gaming platform. The cloud-based software tool may, in some cases, provide a statistical analysis of playtime directly from customer service tickets, providing an additional layer of insights that can inform both customer service and game development strategies.

In some embodiments of the disclosed technology, a cloud-based software tool may be provided. The cloud-based software tool may be used by, for example, a customer-support ticketing system of an online gaming platform. The cloud-based software tool may, in some cases, provide real-time analysis that may automatically pull the latest hour of customer service tickets, ensuring real-time insights for quick and effective decision-making.

In some embodiments of the disclosed technology, a cloud-based software tool may be provided. The cloud-based software tool may be used by, for example, a customer-support ticketing system of an online gaming platform. The cloud-based software tool may, in some cases, be specifically designed to integrate the use of Large Language Models (LLMs), with data analytics and infographic creation to provide real-time insights to users, such as customer service agents tasked to handle tickets of the customer-support ticketing system. Real-time insights may include, for example, customer complaints, issues, feedback, or the like. Additionally, or alternatively, the cloud-based software tool may automate the analysis of customer service tickets created by the customer-support ticketing system. Customer service ticket analysis may, in some cases, allow customer service agents to become apprised of time-sensitive problems, issues, or trends. In some embodiments, the customer service ticket analysis may enable quick decision-making by customer service agents to rectify problems in an expeditious manner. For example, through use of the cloud-based software tool to identify one or more issues on the online gaming platform, downtime may be reduced through quick identification of the issues through automated analysis of service tickets.

### Exemplary Computer Network Diagram

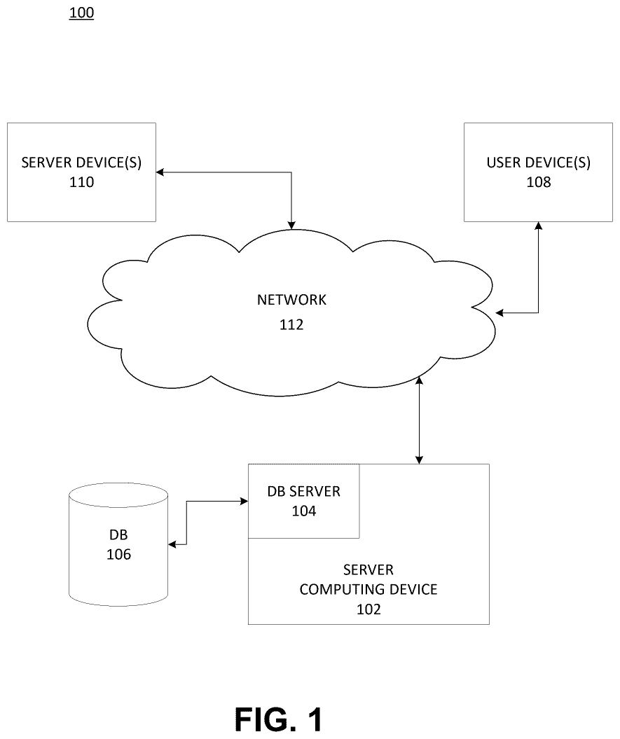

FIG. 1 depicts an exemplary networked computing system 100. Networked computing system 100 may include a server computing device 102. Server computing device 102 may include a database server 104 that may be communicatively coupled to a database 106 that stores data. In one embodiment, database 106 may be a local storage device. In another embodiment, database 106 may be a remote storage device, such as cloud storage, or the like. Server computing device 102 may be in communication with a plurality of user device(s) 108. Server computing device 102 may also be in communication with a plurality of server device(s) 108.

In the exemplary embodiment, user devices 108 may be computers that include a web browser or a software application, user devices 108 to access remote computer devices, such as server computing device 102, using the Internet or other network, such as network 112. More specifically, user device(s) 108 may be communicatively coupled to server computing device 102 through many interfaces including, but not limited to, at least one of the Internet, a network, such as the Internet, a local area network (LAN), a wide area network (WAN), or an integrated services digital network (ISDN), a dial-up-connection, a digital subscriber line (DSL), a cellular phone connection, and a cable modem. User device(s) 108 may be any device capable of accessing the Internet including, but not limited to, a desktop computer, a laptop computer, a personal digital assistant (PDA), a cellular phone, a smartphone, a tablet, wearable electronics, smart watch, or other web-based connectable equipment or mobile devices.

### Exemplary User Device

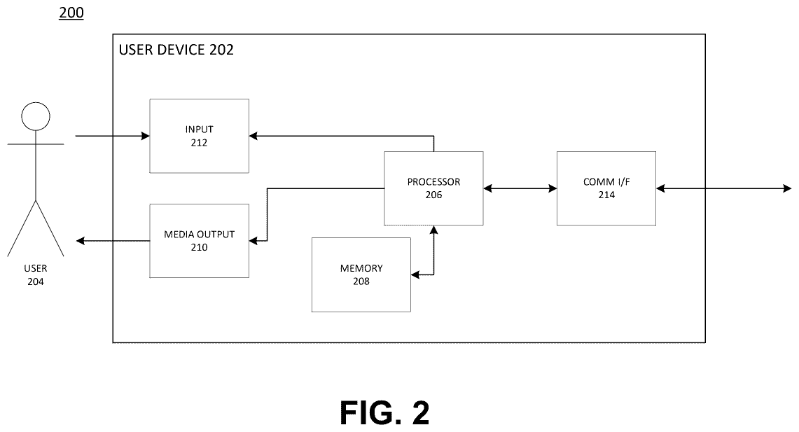

FIG. 2 depicts an exemplary configuration 200 of a user computer device 202, in accordance with one embodiment of the present disclosure. User device 202 may be operated by a user 204. User device 202 may include, but is not limited to, user device(s) 108 (shown in FIG. 1). User device 202 may include a processor 206 for executing instructions. In some embodiments, executable instructions may be stored in a memory 208. Processor 206 may include one or more processing units (e.g., in a multi-core configuration). Memory 208 may be any device allowing information such as executable instructions and/or transaction data to be stored and retrieved. Memory 208 may include one or more computer readable media.

User device 202 may also include at least one media output component 210 for presenting information to user 204. Media output component 210 may be any component capable of conveying information to user 204. In some embodiments, media output component 210 may include an output adapter (not shown) such as a video adapter and/or an audio adapter. An output adapter may be operatively coupled to processor 206 and operatively coupled to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 210 may be configured to present a graphical user interface (e.g., a web browser and/or a client application) to user 204. In some embodiments, user device 202 may include an input device 212 for receiving input from user 204. User 204 may use input device 212 to, without limitation, provide user data, customer ticket information, or the like.

Input device 212 may include, for example, a keyboard, a pointing device, a mouse, a stylus, a touch sensitive panel (e.g., a touch pad or a touch screen), a gyroscope, an accelerometer, a position detector (e.g., a GPS sensor), a biometric input device, and/or an audio input device. A single component such as a touch screen may function as both an output device of media output component 210 and input device 212.

User device 202 may also include a communication interface 214, communicatively coupled to a remote device such as server computing device 102 or server device(s) 110 (shown in FIG. 1). Communication interface 214 may include, for example, a wired or wireless network adapter and/or a wireless data transceiver for use with a mobile telecommunications network.

Stored in memory 208 are, for example, computer readable instructions for providing a user interface to user 204 via media output component 210 and, optionally, receiving and processing input from input device 212. A user interface may include, among other possibilities, a web browser and/or a client application. Web browsers enable users, such as user 204, to display and interact with media and other information typically embedded on a web page or a website from server computing device 102 or server device(s) 110 (shown in FIG. 1). A client application (e.g., an application associated with server computing device) may allow user 204 to interact with, for example, server computing device 102 or server device(s) 110 (shown in FIG. 1). For example, instructions may be stored by a cloud service, and the output of the execution of the instructions sent to the media output component 210. Exemplary Implementation of a Cloud-based Automatic Helpdesk Explainer Application

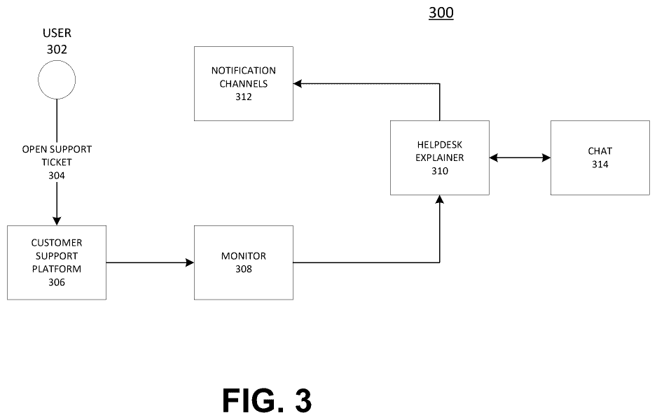

FIG. 3 depicts an exemplary method 300 for application flow for a cloud-based automatic helpdesk explainer application. Method 300 may be performed by server computing device 102 (shown in FIG. 1). Further, steps of method 300 may be performed in conjunction with one or more user device(s) 108 and one or more server device(s) 110, as shown in the exemplary configuration illustrated in FIG. 1. Elements and components of the cloud-based automatic helpdesk explainer application may be stored on a storage device, such as database 106 (shown in FIG. 1). The cloud-based automatic helpdesk explainer application may be made accessible via a network, such as the Internet. In some embodiments, the cloud-based automatic helpdesk explainer application may be accessible to a certain group of users, such as via a private network. The cloud-based automatic helpdesk explainer application may be made accessible to a plurality users via one or more client devices, a plurality of customer service agents, or the like.

In some embodiments, the cloud-based automatic helpdesk explainer application may be accessible via a mobile device application. A mobile device application may be made available to a user on a user device 108 associated with the user. Further, the cloud-based automatic helpdesk explainer application may be hosted by and/or in communication with server computing device 102. Alternatively, the cloud-based automatic helpdesk explainer application may be accessible via a desktop application, a web-based interface, or the like.

Method 300 may include a user, such as user 302, opening 304 a customer support ticket which may be sent to a customer support platform 306. In some embodiments, the cloud-based automatic helpdesk explainer application may be used in conjunction with or by a customer-support ticketing system. In some embodiments, the customer-support ticketing system may be used by, for example, an online gaming platform as a way for platform users to submit problem tickets. A user may submit a problem ticket when they encounter an issue during gameplay. For example, during gameplay, a user may submit a ticket when they encounter an issue (e.g., software bugs, incorrect game payouts, incorrect game rewards).

Method 300 may include a monitor 308 used to track, filter, and analyze tickets received by customer support platform 306. In some embodiments, monitor 308 may collect and store customer service ticket data. Additionally, or alternatively, monitor 308 may collect and send the customer service ticket data to another device, such as helpdesk explainer 310. In some embodiments, the collected customer service data may be transmitted to helpdesk explainer 310 on a periodic basis (e.g., once an hour, once a day). Additionally, or alternatively, the collected customer service data may in response to one or more triggering events. A triggering event may occur when, for example, one or more thresholds are reached or surpassed. For example, if at least ten problem tickets pertaining to the same issue are received within a set duration (e.g., 15 minutes, one hour), the collected customer service data associated with the ten problem tickets may be transmitted for additional processing, such as to helpdesk explainer 310.

Method 300 may include a helpdesk explainer 310 used to analyze and process customer service data. In some embodiments, helpdesk explainer 310 may receive customer service data from customer support platform 306 via monitor 308. Additionally, customer service data may include a plurality of customer service tickets that are like each other, as determined by monitor 308. Similarity may be based on, for example, keywords, game title, issue, trends, time-sensitive problems, topics, or the like. Helpdesk explainer 310, using one or more large language models (LLMs) and/or natural language processing (NLP), may be enabled to create data analytics and infographics. In some embodiments, helpdesk explainer 310 may generate an API call to chat 314. Chat 314 may be, for example, a generate AI chat application with access to an LLM, such as chat-bison or the like. In some embodiments, helpdesk explainer 310 may generate a prompt that is sent to the LLM hosted on chat 314. The data analytics and infographics may, in some cases, provide real-time insights for use by customer service agents, or others, to address time-sensitive problems.

Additionally, applications of the helpdesk explainer 310 may automate the analysis of the customer service data, enabling quick decision-making by the customer service agents. In some embodiments, the data analytics and infographics may include a summary of the customer service data arranged into key words or topics, enabling the customer service agents to identify recurring time-sensitive problems, issues, or trends. Additionally, or alternatively, the data analytics and infographics may offer playtime analytics that may be used to statistically analyze playtime data. Analysis of playtime data may provide an understanding of how to improve the user experience and identify if there are any issues affecting new or seasoned players. Additionally, statistical analysis of playtime data may provide insights into how issues may be affecting new or seasoned players differently. In some embodiments, data analytics may be provided as a themed infographic. For example, the data analytics may be in the form of an infographic that is styled and themed according to a particular game, such as a game offered on an electronic gaming platform, a game offered on a mobile platform, or an electronic gaming machine (EGM) game. This may, in some cases, make the data easier to interpret and be more engaging for game developers and customer service teams.

Method 300 may include notification channels 312. The data analytics and infographics may be provided as output by helpdesk explainer 310 to notification channels 312. Notification channels 312 may include, for example, an email alert, a slack alert, or the like. Exemplary Application Flow

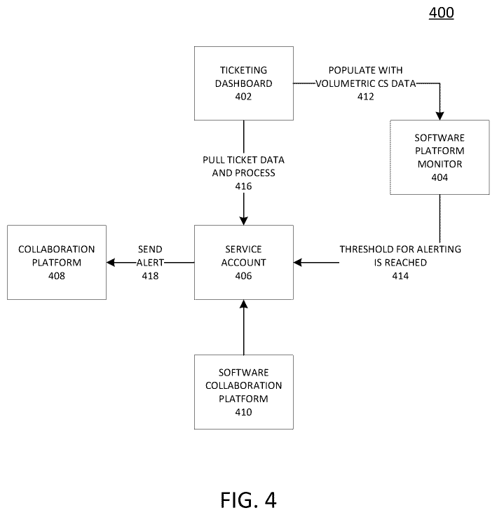

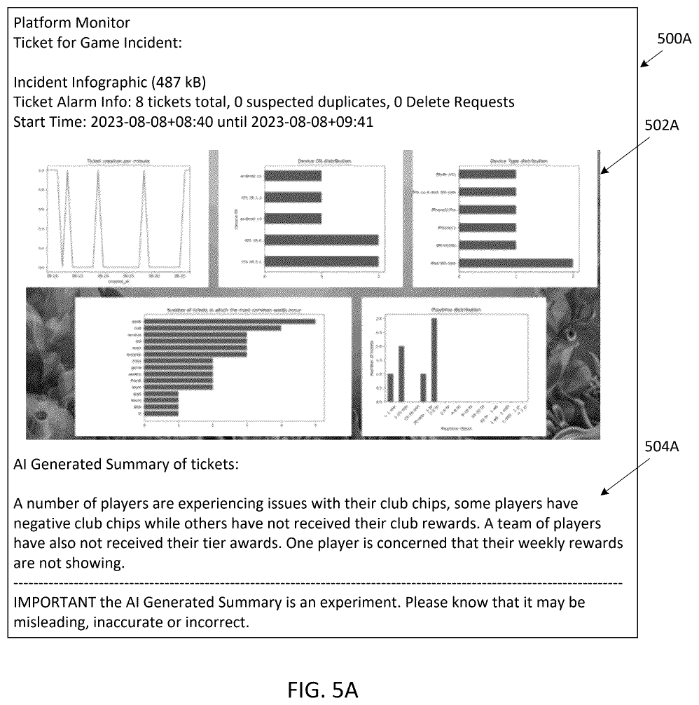

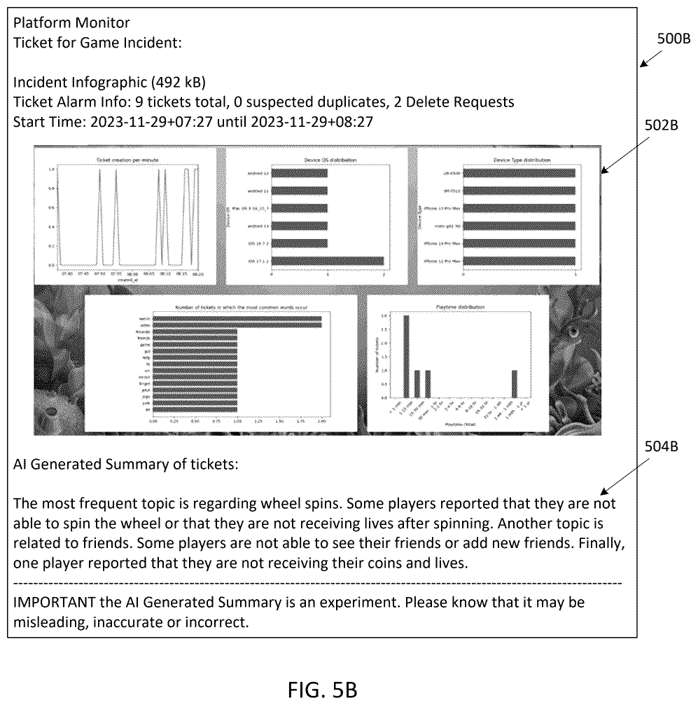

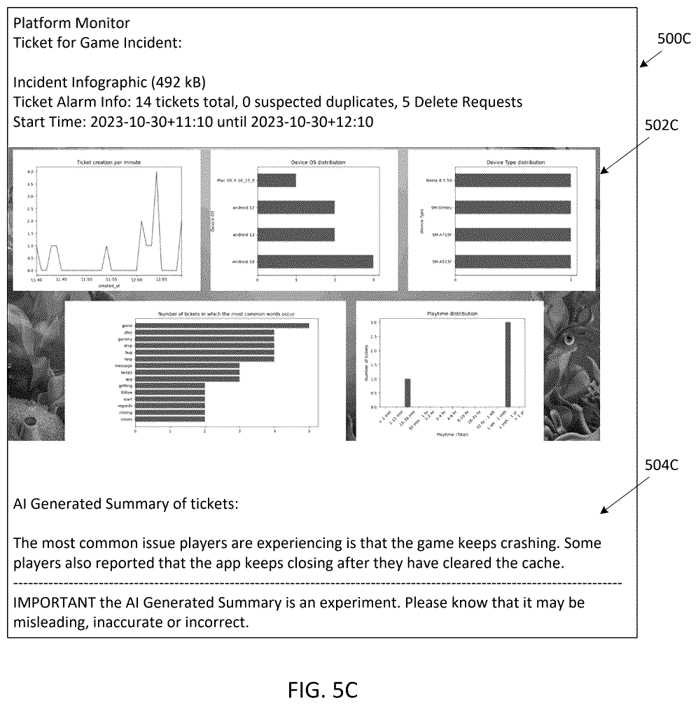

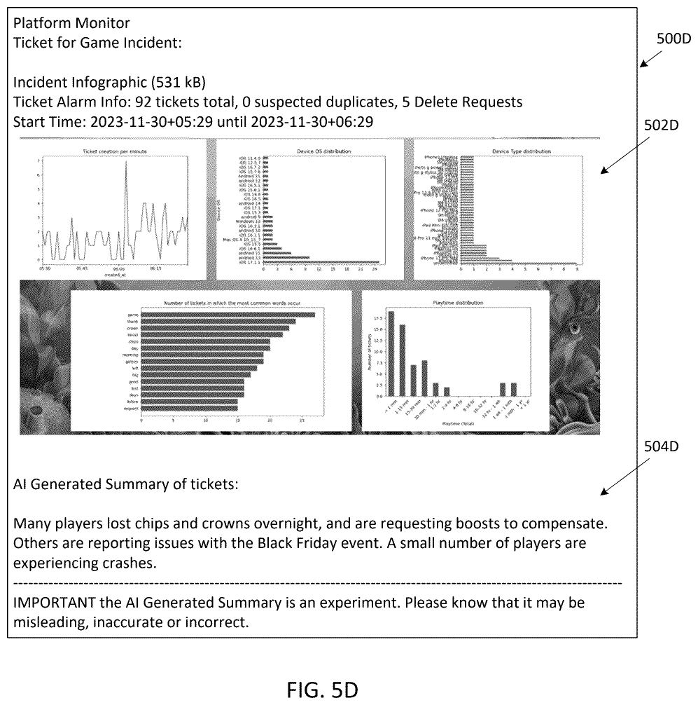

FIG. 4 depicts an example architecture 400 of the cloud-based platform and system. Block diagram 400 of FIG. 1 includes ticketing dashboard 402, software platform monitor 404, service account 406, collaboration platform 408, and software collaboration platform 410. In one example, Ticketing dashboard 402 may populate 412 software platform monitor 404 with volumetric customer service data. Software platform monitor 404 may generate an alert and send the alert to service account 406 when a threshold for alerting is reached 414. Upon receiving the alert, service account 406 may pull ticket data and process the ticket data. Service account 406 may pull ticket data from ticketing dashboard 402. After processing, service account 406 may send an alert to collaboration platform 408. Additionally, or alternatively, service account 406 may provide processed data to software collaboration platform 410. In some embodiments, the alert provided by service account 406 may include non-LLM generated data, an LLM-generated summary, or a combination thereof. Examples of the alert generated by service account 406 are depicted in FIGS. 5A-5D.

### Exemplary Alerts Generated by the Application Flow

FIGS. 5A-5D depict examples of infographics that may be generated by the disclosed cloud-based automatic helpdesk explainer application, such as helpdesk explainer 310 shown in FIG. 3 or service account 406 shown in FIG. 4. For example, as shown in FIGS. 5A, 5B, and 5C, generated reports 500A, 500B, and 500C each include respective incident infographics 502A, 502B, and 502C. Additionally, each of the generated reports 500A, 500B, and 500C each include respective AI-generated summaries 504A, 504B, and 504C. Each of the example reports may include data pertaining to infographic size, alarm, or alert information (e.g., total number of tickets, duplicates, delete requests), as well as time stamp information. The AI-generated summaries may be provided by a chat feature that includes artificial intelligence capabilities. The example reports of FIGS. 5A, 5B, and 5C are merely provided as examples and are in no way meant to be limiting. The reports generated by the cloud-based software tool may include additional, less, or alternate output and analysis results, including those discussed elsewhere herein.

### Exemplary Application Flow Diagram

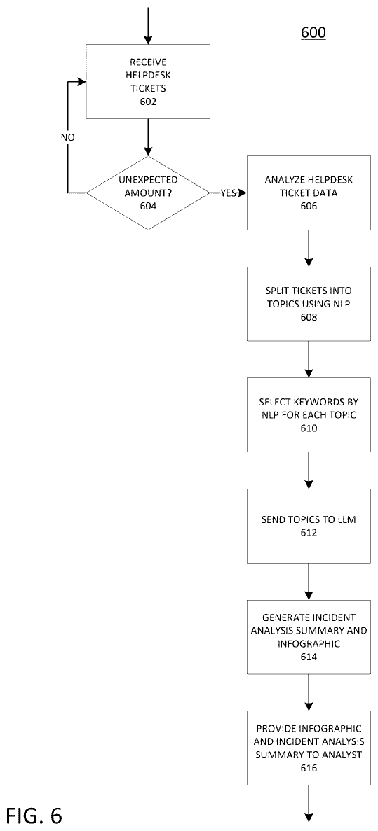

FIG. 6 depicts an exemplary method 600 for a cloud-based automatic helpdesk explainer software tool. Method 600 may be performed by server computing device 102 (shown in FIG. 1). Further, steps of method 600 may be performed in conjunction with one or more user device(s) 108 or one or more server device(s), as shown in the exemplary configuration illustrated in FIG. 1. In some embodiments, exemplary method 600 may be implemented as a software instance on a cloud computing server. Additionally, or alternatively, method 600 may be implemented as a cloud-based software tool integrated with a customer ticketing platform and/or an online gaming platform.

In some embodiments, the cloud-based automatic helpdesk explainer software tool may be accessible via a mobile device application. A mobile device application may be made available to a user on a user device 108 associated with the user. Further, the software tool may be hosted by and/or in communication with server computing device 102. Alternatively, the software tool may be accessible via a desktop application, a web-based interface, or the like.

Method 600 may include receiving 602 helpdesk tickets. Helpdesk tickets may be received in the form of customer service tickets, customer feedback messages, customer suggestion messages, or the like. For example, during gameplay, if an error an unexpected event occurs (e.g., game glitch, incorrect game result), a user may be provided with an opportunity to submit a problem ticket, such as via a clickable icon on a user interface. Additionally, or alternatively, the user may be provided with an opportunity to submit feedback or suggestions, such as via a clickable icon on the user interface. Further, the opportunity to submit a problem ticket or feedback/suggestions may be made during actual gameplay or at different times (e.g., game menu). In some embodiments, problem tickets may be automatically generated, such as in response to an error during gameplay, a crash event, or the like.

Method 600 may include, when an unexpected amount of helpdesk tickets is received 604, Method 600 may include analyzing 606 the helpdesk ticket data. Alternatively, when an unexpected amount of helpdesk tickets is not received, method 600 continues receiving 602 helpdesk tickets. The unexpected amount of helpdesk tickets may be set to a certain threshold using a time parameter. For example, 604 may be triggered if a number of helpdesk tickets (e.g., 10, 100, 1000) is received within a certain time interval (e.g., 10 seconds, 10 minutes, 1 hour). The threshold level of tickets and time interval parameters may be user-configurable parameters. Further, parameters may be largely dependent on number of players, time of day, age of game, or the like. In some embodiments, 604 may be triggered based on ticket type in addition to amount of tickets. For example, a first threshold set may be set for the amount of tickets received (e.g., 50) during a time interval (e.g., 15 minutes) and any ticket type. A second threshold may be set for amount of ticket received (e.g., 10), during a time interval (5 minutes, and ticket type (e.g., game error).

Method 600 may include splitting 608 the helpdesk tickets into topics. Splitting 608 may include the use of a natural language processor (NLP). Once split, method 600 may include sending 612 the topics to a large language model (LLM). Sending 612 may include building a prompt that is provided to the LLM. Results from the LLM and/or results from analysis 604 may be used by method 600 to generate 614 a report including an incident analysis summary and infographic. Method 600 may include providing 616 the generated report to an analyst, such as a customer service agent, or the like.

### Additional Considerations

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A non-transitory computer readable medium comprising computer readable code executable by one or more processors to:
receive a plurality of helpdesk tickets related to one or more games from an online gaming platform;
determine a ticket volume parameter based on the plurality of helpdesk tickets; and
in response to the ticket volume parameter satisfying a predefined threshold:
apply one or more of the plurality of helpdesk tickets to a natural language processor configured to assign the one or more of the plurality of helpdesk tickets to one or more topics;
create an infographic image representing the one or more of the plurality of the helpdesk tickets based on the topics;
apply at least a portion of the topics to a large language model configured to generate a natural language incident analysis summary; and
provide the infographic image and incident analysis summary for presentation at a client device.

2. The non-transitory computer readable medium of claim 1, wherein the client device is associated with a customer service agent.

3. The non-transitory computer readable medium of claim 1, wherein the infographic image and incident analysis summary provide real-time insights of the online gaming platform.

4. The non-transitory computer readable medium of claim 1, wherein each of the plurality of helpdesk tickets are associated with at least one online gaming platform.

5. The non-transitory computer readable medium of claim 1, wherein a presentation style of the infographic image and incident analysis summary correspond to at least one of the one or more games from the online gaming platform associated with one or more of the plurality of helpdesk tickets.

6. The non-transitory computer readable medium of claim 1, wherein the natural language processor is configured to assign the one or more of the plurality of helpdesk tickets to a predefined number of topics.

7. The non-transitory computer readable medium of claim 1, wherein the at least a portion of the topics is used to build a prompt for the large language model configured to generate the natural language incident analysis summary.

8. A method, comprising:
receiving a plurality of helpdesk tickets related to one or more games from an online gaming platform;
determining a ticket volume parameter based on the plurality of helpdesk tickets; and
in response to the ticket volume parameter satisfying a predefined threshold:
applying one or more of the plurality of helpdesk tickets to a natural language processor configured to assign the one or more of the plurality of helpdesk tickets to one or more topics;
creating an infographic image representing the one or more of the plurality of the helpdesk tickets based on the topics;
applying at least a portion of the topics to a large language model configured to generate a natural language incident analysis summary; and
providing the infographic image and incident analysis summary for presentation at a client device.

9. The method of claim 8, wherein the client device is associated with a customer service agent.

10. The method of claim 8, wherein the infographic image and incident analysis summary provide real-time insights of the online gaming platform.

11. The method of claim 8, wherein each of the plurality of helpdesk tickets are associated with at least one online gaming platform.

12. The method of claim 8, wherein a presentation style of the infographic image and incident analysis summary correspond to at least one of the one or more games from the online gaming platform associated with one or more of the plurality of helpdesk tickets.

13. The method of claim 8, wherein the natural language processor is configured to assign the one or more of the plurality of helpdesk tickets to a predefined number of topics.

14. The method of claim 8, wherein the at least a portion of the topics is used to build a prompt for the large language model configured to generate the natural language incident analysis summary.

15. A system, comprising:
a memory comprising instructions that when executed by a processor implement:
receiving a plurality of helpdesk tickets related to one or more games from an online gaming platform;
determining a ticket volume parameter based on the plurality of helpdesk tickets; and
in response to the ticket volume parameter satisfying a predefined threshold:
applying one or more of the plurality of helpdesk tickets to a natural language processor configured to assign the one or more of the plurality of helpdesk tickets to one or more topics;
creating an infographic image representing the one or more of the plurality of the helpdesk tickets based on the topics;
applying at least a portion of the topics to a large language model configured to generate a natural language incident analysis summary; and
providing the infographic image and incident analysis summary for presentation at a client device.

16. The system of claim 15, wherein the client device is associated with a customer service agent.

17. The system of claim 15, wherein the infographic image and incident analysis summary provide real-time insights of the online gaming platform.

18. The system of claim 15, wherein each of the plurality of helpdesk tickets are associated with at least one online gaming platform.

19. The system of claim 15, wherein a presentation style of the infographic image and incident analysis summary correspond to at least one of the one or more games from the online gaming platform associated with one or more of the plurality of helpdesk tickets.

20. The system of claim 15, wherein the natural language processor is configured to assign the one or more of the plurality of helpdesk tickets to a predefined number of topics.
